(19) United States
(12) Patent Application Publication
(10) Pub. No.: US 2002/0063157 A1
(43) Pub. Date: May 30, 2002

(54) Auto settlement system using locker

(75) Inventor: Kouichiro Hara, Tokyo (JP)

Correspondence Address: ARMSTRONG,WESTERMAN & HATTORI, LLP, 1725 K STREET, NW., SUITE 1000, WASHINGTON, DC, 20006, US

(73) Assignee: Kabushiki Kaisha Fulltime System, Tokyo (JP)

(21) Appl. No.: 09/725,448

(22) Filed: Nov. 30, 2000

(30) Foreign Application Priority Data
Feb. 1, 2000 (JP) JP 2000-023831
Apr. 27, 2000 (JP) JP 2000-126957
Jul. 24, 2000 (JP) JP 2000-222239
Nov. 1, 2000 (JP) JP 2000-334462

(51) Int. Cl. G06F 7/00; G06F 7/04; H04Q 9/00; G08C 19/00; G05B 23/00; B60R 25/00; G08B 29/00; G06K 7/10; G06K 19/06; G06F 17/60; H04Q 1/00; H04B 1/00; H04B 3/00; G05B 19/00

(52) U.S. Cl. 235/462.02; 340/5.73; 705/1

(57) ABSTRACT

At the time of delivery of an article for which payment is to be made by using the locker, conventionally, the resident later utilizes a bank or a post office to transfer money to the trader. Therefore, the resident has to go to the bank or post office, and hence there is a problem in that the procedure is troublesome. An auto settlement system using a locker comprising: a card reader 12c for reading a trader identifier decided beforehand by a contract between a proprietary company of the locker and a trader; operation keys 12b for inputting a recipient identifier or the like; a sensor 12d for detecting whether there is an article or not in a box 11 of the locker; an electric lock 12h for locking a door of the box when the sensor detects said article; and a central control unit 12a for storing the recipient identifier and transmitting such data to the control center.

### BACKGROUND OF THE INVENTION

1. Field of the Invention

The present invention relates to a locker installed at an entrance of an apartment or a tenant building for dispatching goods by using a home delivery service or accepting laundry that has been dry cleaned or catalog sales commodities on behalf of a resident when he/she is out, and also relates to an auto settlement system using the locker in which the settlement can be made via the locker when a settlement of accounts occurs between the resident and a trader via the lockers.

2. Description of the Related Art

Conventionally, a locker installed at an entrance of an apartment or a tenant building can accept a commodity from traders for residents, or accept such commodity from residents for traders. In either case, there may be a case where a settlement of account is left to be done. For example, there are cases in which the residents wish to dispatch a parcel containing an article utilizing a home delivery service, and in which a commodity is to be delivered by a trader to a resident with the payment for the purchase price being left to be done.

At the time of delivery of a commodity for which a purchase money thereof is left to be done by using the locker, the resident conventionally utilizes a bank or a post office later to transfer money to the trader. Therefore, the resident has to go to the bank or post office, and such practice has a problem that the procedure therefore is troublesome.

### SUMMARY OF THE INVENTION

The present invention is to solve the aforementioned problem, and it is an object of the present invention to provide an auto settlement system using a locker, wherein settlement of accounts from residents to traders can be made by using a reader means installed in the locker to read a trader identifier cards such as credit cards, electronic cards, debit cards, a bar code or the like.

The auto settlement system using a locker of the present invention is to achieve the above-described object, and comprises: reader means for reading a trader identifier decided beforehand by a contract between a proprietary company of the locker and a trader; operation keys for inputting a recipient identifier, amount and the like; a sensor for detecting whether or not there is an article in a box of the locker; an electric lock for locking a door of the box when the sensor detects the article; and a central control unit for storing the recipient identifier, amount and trader's name, and transmitting these data to the control center.

It is also characterized in that said article data thereof being input by said operation keys is priced higher than a preset amount such that each box of the locker rejects to accept said article therewithin.

Moreover, when an article deposited in the locker is to be taken out with a purchase money thereof being unsettled, a recipient identifier decided beforehand under a contract with a proprietary company of said locker is read by reader means installed in said locker, or a password given by said proprietary company is input with operation keys to thereby open the door of a box in said locker, and the recipient identifier or password is stored in a central control unit of said proprietary company such that said proprietary company can pay the purchase money by the recipient identifier or password to a trader of the article.

Also, the payee and the charge are read by a bar code reader from a bar code printed on a bill from a control center which is entrusted with collecting money of, for example, public utilities charges such as telephone, city water, gas and electricity, or rents and maintenance fee by an owner of the house, a proprietary company and a management union, by use of a bar code reader installed in the locker, and a recipient identifier decided beforehand by a contract with the proprietary company of the locker is read by reader means installed in said locker, or a password given by said proprietary company is input with operation keys, to thereby store said recipient identifier or password in a central control unit of said proprietary company such that said proprietary company can pay the amount of money settled by said recipient identifier or password to public utilities service companies or consignors.

Furthermore, when a member who has made an agreement with a proprietary company accesses at least a shopping mall established by said proprietary company of the locker or a shopping mall on the Internet connected via said shopping mall, using said locker or a computer or portable terminal in the member's house, and purchases a commodity, the settlement of the purchase price of said commodity is performed via said proprietary company, utilizing said locker.

### BRIEF DESCRIPTION OF THE DRAWINGS

FIG. 1 is a schematic diagram showing an embodiment of an auto settlement system using a locker according to the present invention;

FIG. 2 is a circuit block diagram in a control box of the locker in FIG. 1;

FIG. 3 is a flow chart showing a freight depositing operation;

FIG. 4 is a flow chart showing a freight pick-up operation;

FIG. 5 is a block diagram when a settlement of goods purchased on the Internet is made; and

FIG. 6 is a block diagram when a control center is entrusted with collecting money from a consignor to.

### DESCRIPTION OF THE PREFERRED EMBODIMENTS

An embodiment of an auto settlement system using a locker according to the present invention will now be described with reference to accompanying drawings.

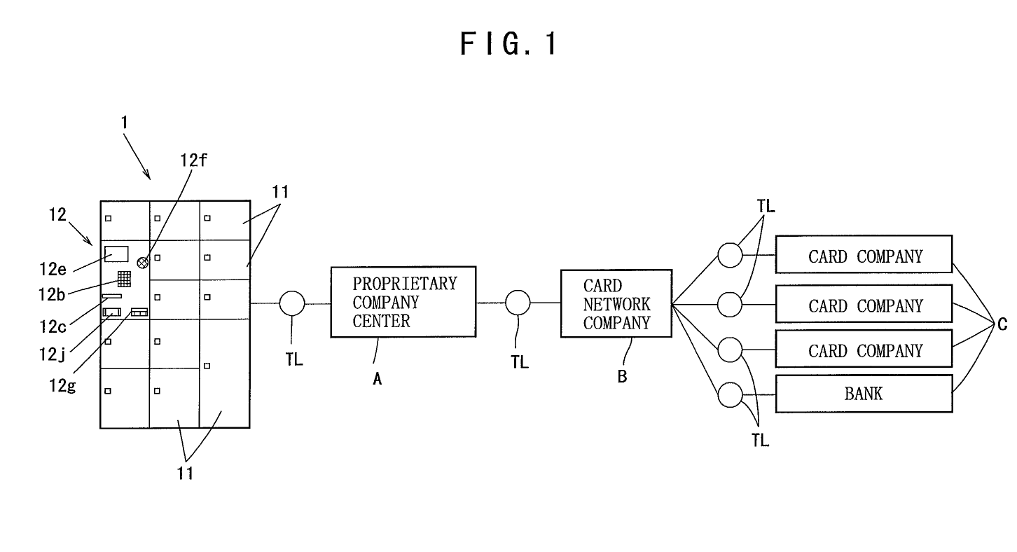

FIG. 1 shows the overall construction, wherein reference symbol 1 denotes a locker installed at an entrance of an apartment, a tenant building or the like, and as disclosed in, for example, Japanese Unexamined Patent (Kokai) Publication No. 9-330458 filed by the present applicant, it is constructed such that when a resident is out, a trader can stock goods in the locker and leave a message informing the goods is deposited in the locker in a mail box, and when the resident comes back and sees the message, he/she can open the locker and take it out.

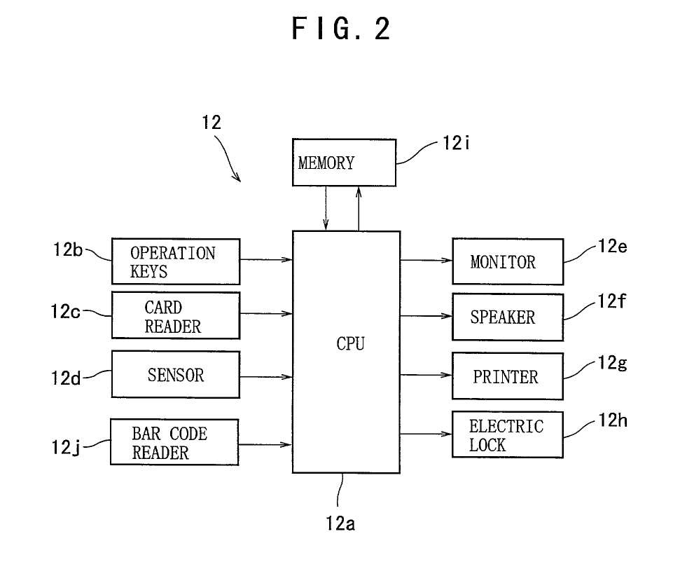

The locker 1 has a plurality of boxes 11 having different sizes, and a control box 12 operated at the time of depositing by the trader and at the time of taking out by the resident. The control box 12 has a construction as shown in FIG. 2.

That is to say, there are a central control unit 12a, and operations keys 12b including ten keys, a release key, a start key or the like; a card reader 12c for reading a card such as a credit card, an electronic card or a debit card; a sensor 12d for detecting that there is an article deposited in the box 11, and it is taken out; a monitor 12e for projecting the operation procedure; a speaker 12f for performing communication with a control center and for aurally explaining the operation procedure (though not shown, a microphone for performing communication with the control center is also installed); a printer 12g for printing a message to the effect that the trader has deposited an article and that settlement of accounts by means of a card described later has been performed; an electric lock 12h for locking the box 11; a memory 12i; and a bar code reader for reading a bar code printed on a bill of, for example, telephone, city water, gas and electricity, and outputting the charge data, all connected to the central control unit 12a.

The central control unit 12a is connected to the control center via a modem (not shown), and constructed so as to perform telephone communication and data transmission with the locker 1.

Returning again to FIG. 1, TL denotes a public or private telephone line; A denotes a control center of a proprietary company for controlling the locker 1, which is connected to the locker 1 via the line TL; B denotes a card network company connected to the control center A via the line TL, which issues a notification of unavailability of a card to member stores of the card, when a card such as a credit card, an electronic card or a debit card is lost or stolen, and also checks misuse at the time of using the card; and C denotes various credit card companies and banks connected to the card network company B via the line TL.

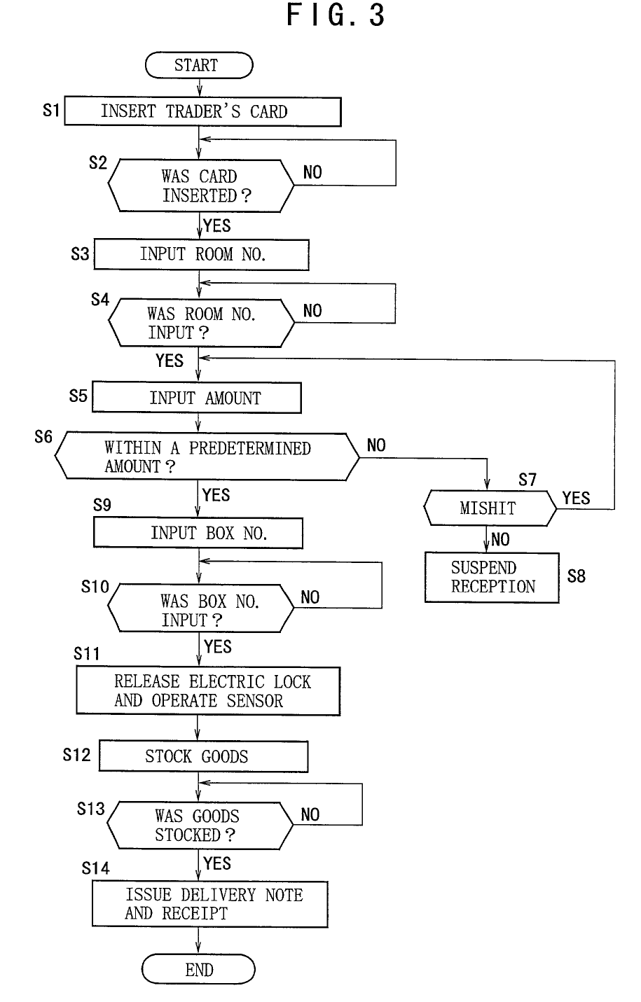

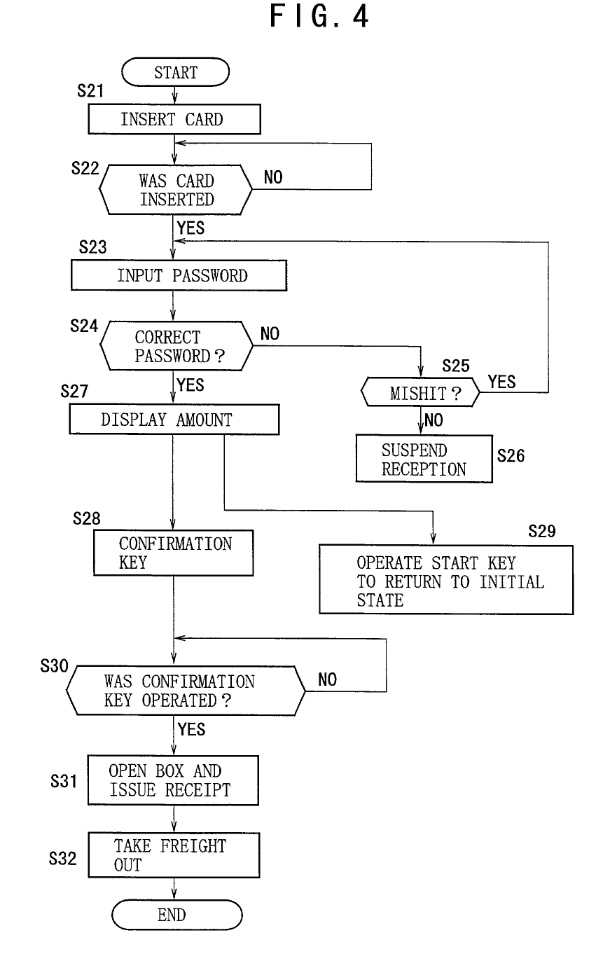

A method of the auto settlement system using a locker will now be described based on the above-described construction, with reference to FIG. 3 and FIG. 4.

At first, a method of depositing an article to the locker 1 which requires collecting money for mail-order traders, laundries who have completed laundering, or the like will be described with reference to FIG. 3. Here, a card to be used for depositing an article for which payment is left to be done by means of the locker 1 is given in advance to regular traders under a contract with the control center A.

For depositing an article for which payment is left to be done, it is required for the trader to insert the pre-given card to the card reader 12c of the control box 12 such that the card is read (step S1). Here, the central control unit 12a judges whether or not the given card is inserted (step S2), and if it is judged that it is the given card, it becomes possible to input the room number of the recipient as a recipient identifier.

Then, the trader inputs the room number by depressing the operation keys 12b (step S3). Here, the central control unit 12a judges whether or not it is a really existing room number (step S4), and if it is judged that it is an existing room number, the trader can input the amount to be settled.

Then, the trader inputs the amount using the operation keys 12b (step S5). Then, the central control unit 12a judges whether or not it is within the pre-set amount (here, it is set within, for example, ¥30,000, such that an expensive commodity can be automatically deposited in order to prevent a problem in the later stage) (step S6), and if it is above that amount, the central control unit 12a waits for a predetermined time such that key operation can be again performed in case where there is be mishit (step S7). Then, after a predetermined time, the central control unit 12a suspends reception of the key operation (step S8).

In the above-described step S5, if it is judged that the amount input by the key operation is within a predetermined range, operation keys 12b can be used for the box number. Therefore, the trader inputs the box number by the key operation where an article is to be deposited (step S9). Here, the central control unit 12a judges whether or not the box number is input (step S10), and if input, the electric lock 12h of the input box number is operated to open the door while the sensor 12d for detecting the existence of the freight starts its operation (step S12).

In this state, when the trader deposit an article in the box, the central control unit 12a monitors whether or not the article is deposited, that is, whether or not the sensor 12d detects the freight (step S13), and if it is judged that the article is deposited, the door of the box is closed, and at the same time, the electric lock 12h resumes to lock the door. Then, after the door is locked, the printer 12g operates to issue a delivery note and a receipt on which the name of consignee, the room number, the date, the amount and the name of the trader are printed (step S14).

The trader who received this delivery note and the receipt puts the delivery note in the mailbox of the same room number and takes the receipt, thus completing the depositing operation. The contents described in the receipt are stored in the memory 12i, and stored in a computer installed in the control center A to access the computer.

Next, there is given an explanation of a method for taking out the article deposited in the box, for which payment is to be made. As a credit card or the like for taking out the deposited article for which payment is to be made, only a card specified in the agreement concluded with the control center A is available.

At first, when the resident who sees the delivery note posted in the mail box, or is informed by the deposit data stored in the computer in the control center A, takes out the article, he/she inserts the credit card in the card reader 12c (step S21). Here, the central control unit 12a judges whether or not the card is inserted, and if it judges that the card is inserted, the central control unit 12a then judges whether or not it is a card which is made available beforehand with the control center A, and enables the inputting of a password (step S22).

Here, when the inputting of the password is enabled, the resident inputs the password by means of the operation keys 12b (step S23), the central control unit 12a judges whether or not the password is correct (step S24) and if it judges that the input password is correct, it waits for a predetermined time such that the key operation can be performed again because it may be a mishit (step S25). Then, after a predetermined time, the central control unit 12a suspends reception of the key operation (step S26).

In the above-described step S24, if it is judged that the password is correct, the purchase price of the article stored in the memory 12i is displayed on the monitor 12e (step S27). Then, the resident, checks whether or not it coincides with the price that he/she has agreed to or the charge he/she agreed to under the contract concluded with the laundry, and if it is correct, presses the confirmation key of the operation keys 12b (step S28), and if it is not correct, presses the start key in the operation keys 12b (step S29).

In the above-described step S29, if the start key is operated, the process resumes to the initial state, making taking out of the article impossible and data informing the price being different is transmitted to the computer in the control center A. Further, the central control unit 12a monitors whether or not the confirmation key is operated in step S28 (step S30), and if the central control unit 12a judges that it has been operated, the central control unit 12a drives the electric lock 12h of the box accommodating the article the door is opened, and a receipt is issued by the printer (step S31).

Upon issuance of the receipt, the memory 12i stores the information that settlement of accounts by the card is made, and at the time of accessing from the computer in the control center A, the information that the settlement has been made is stored in the computer. The resident takes out the article from the box with the door being opened (step S32), thereby to complete all operations. As the means of settlement of accounts described above, the description has been made of a case where the settlement of accounts is performed by a credit card or a password. However, a personal identification number may be determined beforehand with the control center A such that the settlement is made using only this personal identification number.

Next, there is given an expiation of the system in the case where the settlement of, for example, the telephone, city water, gas or electricity bills, on which a bar code is printed, is made utilizing the locker.

At first, the resident brings the bill to the locker 1, and uses the bar code reader 12j installed in the locker 1 to read the bar code. Here, the bar code reader 12j may be assembled in the locker 1, or may be the one connected by a code and held by hand.

When the bar code is read by the bar code reader 12j, the data including predetermined items such as charged amount or the like are stored in the memory 12i. Then, the resident inserts the card for settlement into the card reader 12c. Then, the operation shown in the flow chart in FIG. 4 is performed, and the charged amount stored in the memory 12i is displayed on the monitor 12e in step S27, and the operator confirms the displayed amount and operates the confirmation key of the operation keys 12b.

When the confirmation key is operated, the CPU 12a causes the printer 12g to issue a receipt in which at least the claimant and the received amount are displayed. As a result, the settlement of accounts by the bill is completed. After completion of this settlement, it is stored in the memory 12i that the settlement of accounts by a card is performed, and at the time of accessing from the computer in the control center A, it is stored in the computer that the settlement of accounts has been made.

When the settlement of accounts by the card is completed, the service fee is drawn from a bank account of the resident by the card company C, and the control center A can obtain a commission income by charging the fee to the traders for the settlement of accounts using the locker 1 by card.

When an article is to be picked from the locker 1 by a home delivery service provider, using a card such as a credit card, the shipping charge is generally unknown to the resident. Therefore, an explanation will be given of the system where the settlement of accounts is performed in the following procedure. At first, the card is inserted into the card reader 12c to open the door of a box and deposit the parcel thereinto. Then, the card number read by the card reader 12c is stored in the memory 12i, and hence the card number is also stored in the computer in the control center A.

Then, the home delivery service provider who has picked the parcel for rendering the home delivery service bills the delivery charge to the control center A, who informs the card company of the card number and the charged amount. Then, the card company C draws the amount from the bank account of the card owner in the same manner as described above, and pays the brokerage commission to the control center A.

If the resident loses the card or has the card stolen, he/she reports the fact to the card network company B, who feeds the number of the lost or stolen card to the computer in the control center A. Then, the card number in question is transmitted from the computer to the locker 1 such that settlement of accounts by that card cannot be made. Moreover, as the above-described means of settlement of accounts, the description has been made of a case where the settlement of accounts is performed by a card or a password. However, a personal identification number may be determined beforehand with the control center A such that the settlement of accounts is be made using only this personal identification number.

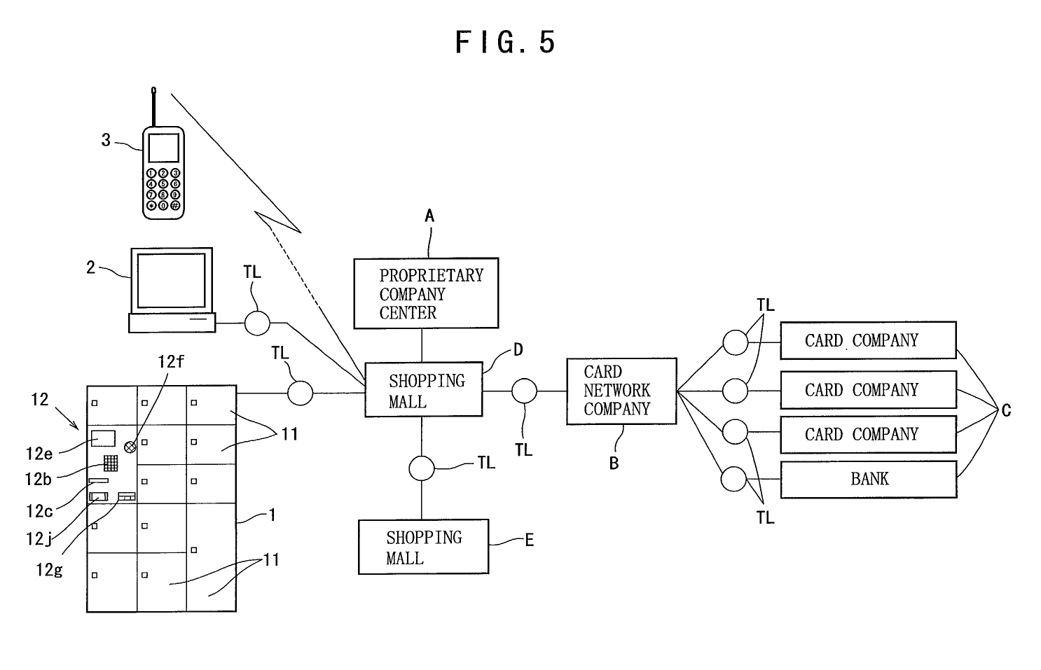

Next, there is given a description of the system when a user accesses a shopping mall on the Internet, by utilizing a computer and a monitor 2e assembled in the locker 1 as shown in FIG. 5, or utilizing a computer 2 in the user's house or a portable terminal (mobile phone or the like) 3 connectable to the Internet to purchase goods, and the settlement of the purchased article is performed at the locker 1 as in the above-described embodiment.

At first, a customer who wants to purchase an article in the shopping mall on the Internet accesses the shopping mall D established by the control center A, by using the locker 1, or the computer 1 in the customer's house, or a portable terminal.

When the shopping mall D is accessed, a screen of the shopping mall D is displayed on a customer's display. When the customer wants to access another shopping mall E, he/she can click a homepage of the other shopping mall E displayed on the screen of the shopping mall D and move there.

Then, the customer searches a desired article from a search screen on the monitor. In this state, the computer in the control center A monitors if purchase of goods is instructed or not in the shopping malls D and E, and when an article to be purchased is determined, a display whether the article is to be delivered to the customer's home or using the locker 1 is shown on the customer's display, and the customer can choose either one of them.

If the customer chooses the locker 1, he/she inputs a card number of a credit card which is notified beforehand to the control center A (taking safety into consideration, it is effective to use a personal identification number notified to the control center A). Upon completion of the above-described processing, the control center A instructs shipment of the article to the locker 1 specified by the customer with respect to a home delivery service provider via a trader who opens a store in the shopping malls D and E.

Then, when the article is deposited in the locker 1 by the home delivery service provider, the control center A receives a article delivery signal. Therefore, it is also possible to notify that the article is deposited in the locker 1 to a communication terminal (for example, telephone (including a mobile phone), facsimile, and electronic mail) predetermined between the user of the locker 1 and the control center A.

Accordingly, the resident who receives this information goes to the locker 1, and can take out the article according to the normal taking out procedure from the locker 1 (that is, utilizing a card given from the control center A). In the above-described embodiment, the explanation has been given of a case where settlement of accounts is made at the time of making an application of purchase of the article. However, in the case where settlement of accounts is made when the deposited article is taken out from the locker 1, the article is taken out by following the operation procedure in the above-described embodiment, that is, by performing the operation based on the flow chart shown in FIG. 3.

In the above-described embodiment, the explanation has been given of a case where an article is purchased by connecting to the other shopping mall E from the shopping mall D established by the control center A. However, if the control center A concludes an agreement with the shopping mall E beforehand, and a screen for enabling deposit of the purchased article in the home delivery locker 1 controlled by the control center A is prepared on the screen of the shopping mall E, the purchaser of the article who wants to deposit the article in the home delivery locker 1 can do a clicking on the screen to automatically access the shopping mall D, and can purchase the article on the screen of the shopping mall D such that the article can be deposited in the home delivery locker 1.

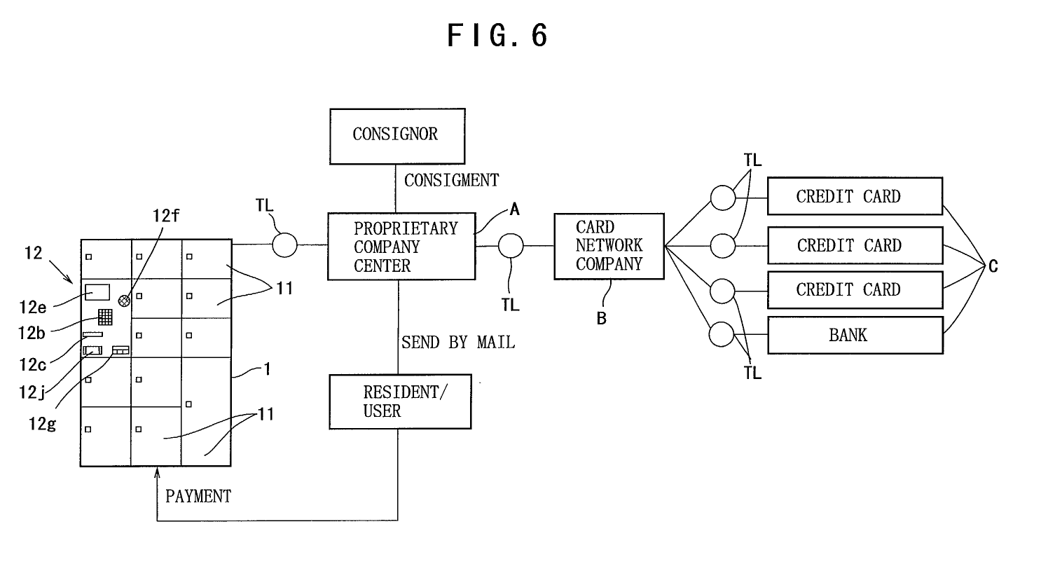

Next, an explanation will be given with regard to the system where a proprietary company entrusted with collecting rents or rendering a cleaning service from an owner of an apartment, or a control center A entrusted with collecting maintenance fee from a management society, shown in FIG. 6, performs collecting money as described above.

At first, the control center A entrusted with collecting money from a consignor F such as owner, proprietary company or management society sends a bill to each resident or user by mail, in which the amount, the user code and monthly data are coded. The resident or user who has received this bill goes to the locker 1 with the bill, and uses the bar code reader 12j to read the bar code printed on the bill.

Thereafter, settlement of accounts is made by a similar operation as with the settlement of public utilities charges using a card, such as the above-described electricity or telephone. Then, the settled amount is paid to the control center A by each card company, and the control center A transfers settled amount of money to a bank account specified by the consignor.

In the above-described embodiment, the explanation has been given with regard to a case where the home delivery locker 1 is installed in an apartment or a tenant building, however, the installation site of the home delivery locker 1 is not limited to the above-described place, and may be installed in any place, for example, private houses, public facilities such as a railway station or the like. In such a case, a membership registration number is used as a recipient identifier in place of the room number. It is important that only a registered person who has made an agreement with the control center 2 can use it.

Further in the above embodiment, a card reader is adapted to read an available card such as a credit card which is registered as means for settlement by use of a password received from a proprietary company. However, a bar code may be read by a bar code reader 12j received as a recipient identifier for making a settlement from the proprietary company.

As described above, since a trader who has made an agreement with the proprietary company of the locker can deposit an article which requires settlement of accounts with the locker, and a trader or a resident of the place where the locker is installed can take out the article, while making a settlement of accounts utilizing an available card such as a credit card which is written in the agreement with the proprietary company, it is not necessary for the trader to collect money and for the resident to go to the bank for payment.

Moreover, a payment of the article purchased by accessing a shopping mall established by the proprietary company or other shopping malls connectable via the aforesaid shopping mall can be made utilizing the locker, and hence settlement becomes simple and safe.

Furthermore, in the case of a bill of public utilities charges such as telephone, city water, gas and electricity, or maintenance fees or rents sent from a control center consigned by a consignor such as an owner, a proprietary company or a management society, having a bar code printed thereon, the settlement of the bill can be made by a card, by reading the bar code with the bar code reader. As a result, the settlement can be made at the locker, without going to a bank or a post office, and hence it is very useful in the future aging society.

It has also an effect of preventing a burden of the resident due to an unforeseen accident, by limiting the amount of settlement within a certain amount of money.

What is claimed is:

1. An auto settlement system using a locker comprising:
reader means for reading a trader identifier decided beforehand by a contract concluded between a proprietary company of lockers and a trader;
operation keys for inputting a recipient identifier;
a sensor for detecting whether or not there is an article in a box of said locker;
an electric lock for locking a door of said box when said sensor detects said article; and
a central control unit for storing data including said recipient identifier, a trader's name or the like to transmit said data to the control center.

2. An auto settlement system using a locker according to claim 1, wherein said article data thereof being input by said operation keys is priced higher than a preset amount such that each box of the locker rejects to accept said article therewithin.

3. An auto settlement system using a locker, wherein when said article deposited in the locker is to be taken out with a purchase money thereof being unsettled, a recipient identifier decided beforehand under a contract with a proprietary company of said locker is read by reader means installed in said locker, or a password given by said proprietary company is input with operation keys to thereby open the door of a box in said locker, and the recipient identifier or password is stored in a central control unit of said proprietary company such that said proprietary company can pay the purchase money by the recipient identifier or password to a trader of the goods.

4. An auto settlement system using a locker, wherein the payee and the charge are read from a bar code printed on a bill from a control center which is entrusted with collecting money of, for example, public utilities charges such as telephone, city water, gas and electricity, or rents and maintenance fee from an owner of the house, a proprietary company and a management society, by a bar code reader installed in the locker, and a recipient identifier decided beforehand by a contract with the proprietary company of the locker is read by reader means installed in said locker, or a password given by said proprietary company is input with operation keys, to thereby store said recipient identifier or password in a central control unit of said proprietary company such that said proprietary company can pay the amount of money settled by said recipient identifier or password to public utilities service companies or consignors.

5. An auto settlement system using a locker, wherein when a member who has made an agreement with a proprietary company accesses at least a shopping mall established by said proprietary company of the locker or a shopping mall on the Internet connected via said shopping mall, using said locker or a computer or portable terminal in the member's house, and purchases an article, the settlement of the purchase price of said article is performed via said proprietary company, utilizing said locker.
